(19) United States
(12) Patent Application Publication
(10) Pub. No.: US 2006/0208036 A1
(43) Pub. Date: Sep. 21, 2006

(54) Tubes with an integrated flange consisting of flexibly rolled material for structural classis and body parts

(76) Inventors: Andreas Hauger, Attendorn (DE); Ute Scheffe, Kreuztal (DE)

Correspondence Address: Wyatt, Gerber & O'Rourke, LLP, 99 Park Avenue, New York, NY, 10016, US

(21) Appl. No.: 11/371,881

(22) Filed: Mar. 9, 2006

(30) Foreign Application Priority Data
Mar. 11, 2005 (DE) 102005011764.3-24

(51) Int. Cl. B23K 31/02

(52) U.S. Cl. 228/173.4

(57) ABSTRACT

A flange tube consisting of plate metal, having a closed cross-section and comprising at least one flange which is integrally produced from the plate metal of the tube body and which extends in the longitudinal direction.

### BACKGROUND OF THE INVENTION

The subject of the invention refers to tubes and profiles for construction of motor vehicle bodies. It is known to produce such tubes and profiles from plate metal by round bending and deep drawing processes. It is also known, for this purpose, to use so-called flexibly rolled material whose wall thickness is variable in the direction of rolling. Material rolled in this way can be used to produce tubes or profiles whose plate thickness varies along their length.

When incorporating such tubes or profiles into a body structure, connecting same to planar plates can be problematical. Such connections are necessary, for example, in cases where the tubes or profiles have to reinforce planar parts such as roofs, doors or hoods.

### FIRST OBJECT OF THE INVENTION

It is the object of the present invention to provide novel tubes or profiles which offer improved connections in the field of vehicle bodies. The objective is achieved by providing a flange tube consisting of plate metal and having a closed cross-section which comprise at least one flange integrally formed out of the plate metal of the tube body and extending in the longitudinal direction of the tube. The necessary connection does not have to be effected at the curved cross-section of the tube body, but can apply to at least one planar flange. The flange can extend along the entire length or it can be limited in the longitudinal direction to the required connecting regions. The latter can be achieved by subsequently removing any flange portions not needed. Preferably, however, when producing the flange tube, the cut is such that the individual longitudinal flange and the flange-less portions are distributed as required.

Equally, depending on the connection required, at least one flange can be aligned in different ways relative to the closed tube body, such an alignment ranging from a tangential to a radial one.

### SUMMARY OF THE INVENTION FOR THE FIRST OBJECT

For closing the tube body to form a closed cross-section, different configurations are possible. According to a first alternative, it is proposed that the plate metal of the tube body joins by means of a free edge thereof in a butt joint to the base region of at least one flange. Alternatively, it is possible for the plate metal of the tube body, by means of a free edge, to project beyond the base region of at least one flange so as to overlap on the inside. Finally, it is possible for the plate metal of the tube body, by means of the free edge bent away from the tube body, to be in lateral parallel contact with at least one flange. It is also possible for two equally wide flange portions to be bent away from the tube body along both edges and to be used to form a double-layer flange. In all cases, the tube body can be longitudinally welded near the base region of at least one flange.

To meet the strength requirements in a more particular way, the plate metal of the tube body can comprise a variable thickness in its cross-section. The flange can consist of a material with a greater thickness if the introduction of force is subject to special loads. On the other hand, the tube body can consist of a plate with a greater thickness if particularly high bending forces are applied to the tube body. Thicker tube region or tube portions can also serve as material reserves for subsequent forming operation carried out on the tube, such as bending or widening.

In other cases, it can be sensible for the plate metal of the tube body to comprise a variable thickness along its length, i.e. the end portions can be thicker or thinner relative to a central region, depending on where the highest loads occur or, in the case of a vehicle crash, where the optimum deformability is located. The thickness of the flange along its length will correspond herein to the wall thickness of the tube body along its length.

The variations in the wall thickness can be pronounced, so that the thinner regions range between 15 and 50% of the thickness of the thicker regions.

Standard sizes of the finished product range between 30 and 150 mm diameter of the tube body and between 20 and 50 mm for the width of at least one flange.

### SECOND OBJECT OF THE INVENTION

Furthermore, it is the object of the invention to propose a suitable process and tool for producing a flange tube with a tube body with a closed cross-section, which flange tube comprises at least one flange integrally produced from the plate metal of the tube body and extending in the longitudinal direction.

### SUMMARY OF THE INVENTION FOR THE SECOND OBJECT

The second objective is achieved by providing a process of producing a flange tube with a tube body with a closed cross-section, which flange tube comprises at least one flange integrally produced from the plate metal of the tube body and extending in the longitudinal direction. A profile is produced with a U-shaped cross-section with parallel arms in a lower first bending die by means of a punch. In a second lower bending die, there is produced from the two arms a tube body with a closed cross-section by means of an upper bending die, wherein at least one of the arms is used to form at least one flange extending in the longitudinal direction.

More particularly, it is proposed that the profile with a U-shaped cross-section is produced with parallel arms of different lengths, wherein the longer arm is finally used to form a flange portion for the at least one flange. Alternatively, it is proposed that the profile with a U-shaped cross-section is produced with parallel arms of identical lengths from which there are produced parallel flange portions of a double-layer flange. Finally, the tube body is welded in the base region of the at least one flange. A particularly cost-effective process consists in that the welding operation takes place simultaneously with the operation of connecting the at least one flange to a third part, i.e. integrating it into a vehicle body structure.

Tools for round-bending plates into a U-shape are known in principle and, in a first process stage, are also used for the above mentioned process. They consist of a lower die part with a semi-cylindrical cross-section and two adjoining parallel flanks and of a corresponding, substantially cylindrical punch. Furthermore, for producing the inventive product, there is proposed a tool for producing a flange tube from plate metal with a tube body with a closed cross-section. The flange tube comprises at least one flange integrally produced from the plate metal of the tube body and extending in the longitudinal direction. A lower die part with a substantially semi-cylindrical receiving trough and an upper die part with a substantially semi-cylindrical forming trough complements the receiving trough to form a cylindrical cross-section. In the forming trough, there is formed a longitudinally extending blade and, in parallel thereto, at least one planar longitudinal slot for receiving the at least one flange. A second longitudinal slot of a lesser depth or identical depth can be provided on the other side of the longitudinally extending blade.

When using the tool, during the round-bending operation, a shorter free arm of the U-shaped profile will abut at the longitudinal blade, whereas a longer free arm on the other side of the longitudinal blade, is bent outwardly and enters the longitudinal slot, so that the flange is formed. If a free edge is to be welded to the flange so as to rest on the outside thereof, as mentioned above, it is possible to form a second longitudinal slot of a lesser depth on the other side of the longitudinal blade, into which slot there is then bent a shorter part of the shorter arm. For forming two flange portions of a double-layer flange, two longitudinal slots of identical depths can be formed on both sides of the longitudinal blade, into which slots two equally long arms are bent symmetrically.

### BRIEF DESCRIPTION OF THE DRAWINGS

Preferred embodiments of the invention referring to both the product and the process of producing same and to the means suitable therefore are illustrated in the drawings and will be described below.

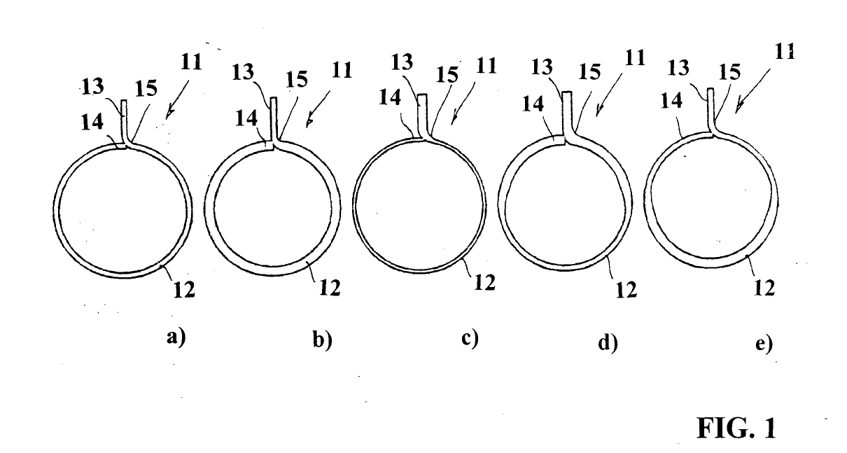

FIG. 1 illustrates different embodiments of three inventive tubes in cross-sectional views as follows:
a) with a constant wall thickness in the cross-section
b) with a greater wall thickness in the tube region than at the flange
c) with a lesser wall thickness in the tube region than at the flange
d) with a variable wall thickness in the tube region and with a maximum wall thickness at the flange
e) with a variable wall thickness in the tube region and with a minimum wall thickness at the flange.

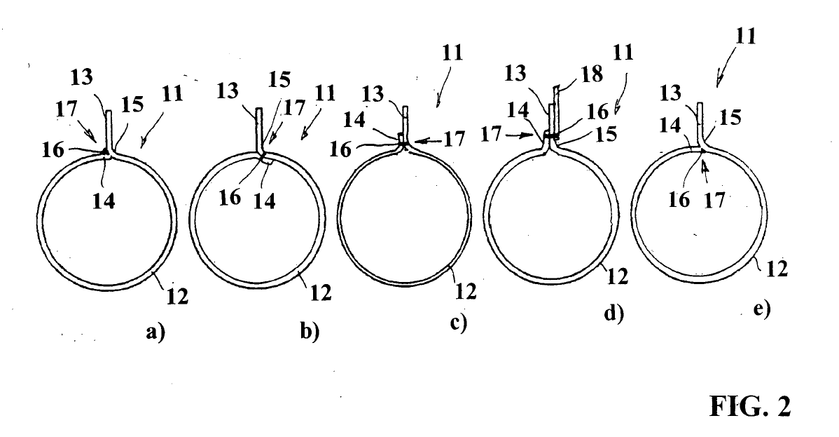

FIG. 2 illustrates different embodiments of the joint and of the weld for the inventive tube as follows:
a) with a butt joint in a first embodiment
b) with internal overlapping in the tube body
c) with external overlapping at the flange
d) with external overlapping with a third part
e) with a different butt joint in a second embodiment.

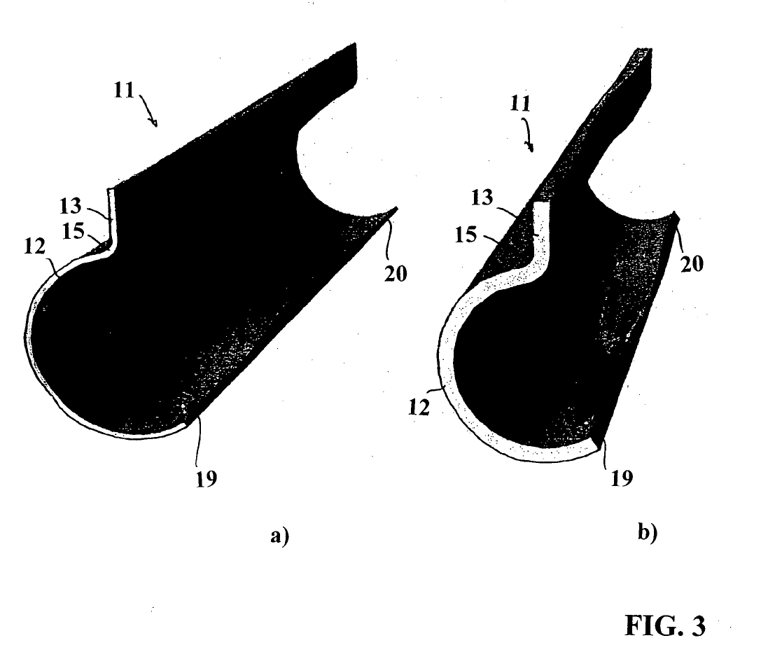

FIG. 3 illustrates the inventive tube whose wall thickness varies along its length, in an illustration in a longitudinal section as follows:
a) with a reduced wall thickness at the axial ends
b) with an increased wall thickness at the axial ends.

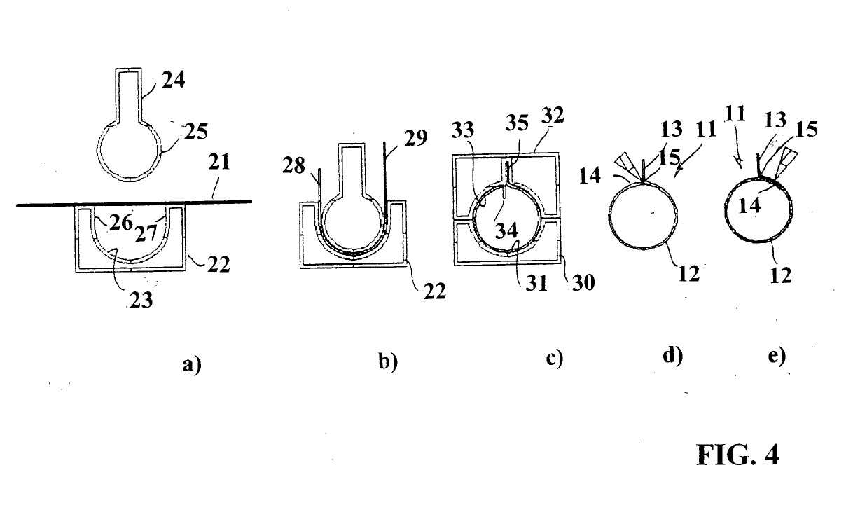

FIG. 4 illustrates the inventive process and an inventive device in a first embodiment as follows:
a) a first lower die and punch in a first phase
b) a first lower die and punch in a second phase
c) a second lower die and upper die in a third phase
d) welding of the product in a first variant
e) welding of the product in a second variant.

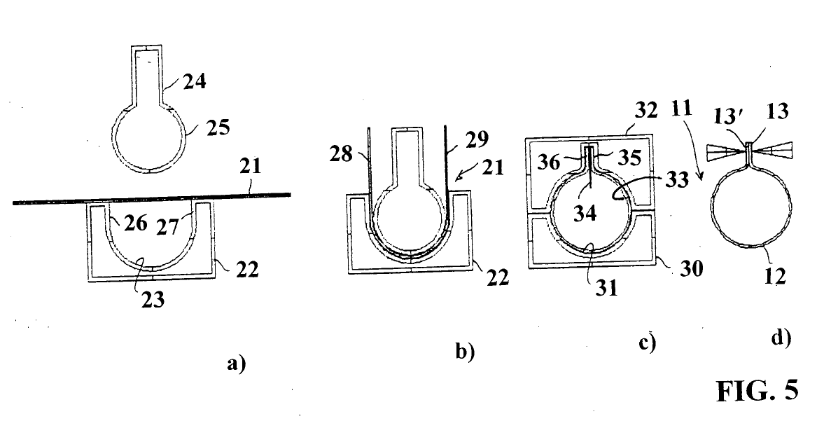

FIG. 5 illustrates the inventive process and an inventive device in a second embodiment as follows:
a) a first lower die and punch in a first phase
b) a first lower die and punch in a second phase
c) a second lower die and upper die in a third phase
d) the operation of welding the product.

### DETAILED DESCRIPTION

FIG. 1 illustrates the inventive flange tube 11 in cross-sectional views in different embodiments; they all show a closed tube body 12 and an integrally formed-on longitudinal flange 13. The free edge 14 of the plate metal of the tube body 12, in the form of a butt joint, abuts the root region or base region 15 of the flange 13. The cross-section of the tube region 12 is circular, with the flange 13 projecting radially from the tube region 12.

In illustration 1a), the tube body 12 and the longitudinal flange 13 are formed from plate metal with a constant thickness.

In illustration 1b), the tube body 12, from the free edge 14 to the base region 15 of the flange 13, is formed from plate metal with a greater thickness, whereas the flange 13 consists of plate metal with a lesser thickness.

In illustration 1c), the tube body 12, from the free edge 14 to the base region 15 of the flange 13, is formed from plate metal with a lesser thickness, whereas the flange 13 consists of plate metal with a greater thickness.

In illustration 1d), the tube body 12 initially comprises a greater thickness from the free edge 14 over a region of approximately 90°, then comprises a region of approximately 180° with a lesser thickness and then again changes into a region with a greater thickness which, via the base region 15 of the flange 13, comprises the flange 13 itself

In illustration 1e), the tube body 12 initially comprises a lesser thickness from the free edge 14 over a region of approximately 90°, then comprises a region of approximately 180° with a greater thickness and then again changes into a region with a lesser thickness which, via the base region 15 of the flange 13, comprises the flange 13 itself.

FIG. 2 illustrates the cross-sectional views of different embodiments of flange tubes which are each formed of plate metal with a constant thickness. Identical details have been given the same reference numbers as used in FIG. 1.

The arrow 17 in each illustration indicates the direction of the introduction of energy and, optionally, the introduction of the welding material when closing the tube body 12.

In illustration 2a), while showing a butt joint between the free edge 14 and the base region 15, a fillet weld 16 has been produced from the outside.

In illustration 2b), while there exists an internal overlap of the free edge 14 over and beyond the base region 15, there is shown a through-weld 16.

In illustration 2c), while the outwardly bent free edge 14 rests against the flange 13, a through-weld 16 has been produced between the superimposed regions of the free edge 14 and the flange 13.

In illustration 2d), with an outwardly bent free edge 14 and external overlapping of the free edge with the flange 13, outside the base region 15, there is shown a through-weld 16 to provide a connection with an additional third part 18. In this way, the tube body 12 is not closed until being connected to the third part 18.

In illustration 2e), with the free edge 14, on the inside, abutting the base region 13, a weld 16 has been produced from the inside with the help of additional welding material. This solution can only be used in a problem-free way for relatively short flange tubes.

In FIG. 3, identical details have been given the same reference numbers as in the preceding figures. Illustrations 3a) and 3b) illustrate a flange tube 11 wherein part of the tube body 12 has been cut away, starting from the free edge 14, over an angle of approximately 120°. The remaining part of the tube body 12, including the radially outwardly bent flange 13 can be seen. The tube body 12 is shown to consist of plate metal having a variable thickness along its length with the variation in thickness being particularly obvious at the lower cutting edge.

In illustration 3a), the plate thickness is reduced towards the ends 19, 20 of the flange tube, whereas it is increased in a central region.

In illustration 3b), the thickness of the plate material is increased towards the axial ends 19, 20, whereas it is reduced in a central region of the flange tube 11.

FIG. 4 illustrates a device and a process for producing the inventive flange tubes. Illustration 4a) shows a planar plate 21 on a first lower die 22 with a forming trough 23 having a U-shaped cross-section. Above the lower die 22 there is shown a bending punch 24 whose operating range 25 comprises a circular cross-section.

In illustration 4b), the punch 24 has been pressed into the bending die 22, with the cross-section of the plate 21 bent into a U-shape and having a shorter arm 28 and a longer arm 29. The two arms extend parallel relative to one another because they rest against the parallel regions 26, 27 of the forming trough 23.

In illustration 4c), an upper die 32 has been pressed on to a second lower die 30 with a semi-cylindrical forming trough 31 into which the plate had been inserted. The upper die 32 has a semi-cylindrical forming trough 33 which finish-bend the plate into substantially round cross-sectional shape. Inside the forming trough 33, there is arranged a radially inwardly projecting blade 34 against which there abuts the shorter arm 28 which thus forms the free edge 14 of the resulting tube body 12.

Furthermore, in the upper die 32, there is shown a slot 35 arranged next to the blade 34 and which is entered by the longer arm 29 of the plate during the round-bending operation. The longer arm 29 is thus bent radially outwardly and forms the flange 13 of the resulting flange tube 11. In illustration 4d) the tube body 12 can be welded at the base region 15 of the flange 13. In illustration 4e) the tube body 12 can be reduced in a further bending die without a blade to such an extent that the free edge 14 can overlap with that part of the tube body 12 which adjoins the base region 15, in which case it is possible to effect, from the outside, radial through-welding in the region of overlap.

FIG. 5 illustrates an additional device and an additional process for producing inventive flange tubes. In illustration 5a), a planar plate 21 has been placed on to a first lower die 22 with a U-shaped forming trough 23. Above the first lower die there is shown a bending punch 24 whose operating range 25 has a circular cross-section.

In illustration 5b), the punch 24 has been pressed into the bending die 22, with the plate 21 having been bent into a U-shaped cross-section, in this case having two arms 28, 29 of identical lengths. The two arms extend parallel relative to one another because they rest against the parallel regions 26, 27 of the forming through 23.

In illustration 5c), an upper die 32 has been pressed onto a second lower die 30 with a semi-cylindrical forming trough 31 into which the plate was inserted. The upper die 32 comprises a semi-cylindrical forming trough 33 which bends the plate into a substantially round cross-sectional shape. Inside the forming trough 33, there is arranged a radially inwardly projecting blade 34 against which the arms 28, 29 initially abut. Furthermore, in the upper die 32 there is shown two slots 35, 36 which are arranged on either side of the blade 34 so as to adjoin same and which are entered by the arms 28, 29 of the plate during the round-bending operation. The arms 28, 29 are bent radially outwardly and form equally wide flange portions 13, 13′ of the resulting flange tube 11. In illustration 5d) the tube body 12 can be welded in the region of the flange portions 13, 13′. If the slot 36 has been selected to be shorter than the slot 35, the flange tube can also be given the configuration as shown in FIG. 2c.

1. A flange tube which is made out of plate metal with a closed cross-section and which comprises at least one flange integrally produced from the plate metal of the tube body and extending in the longitudinal direction.

2. A tube according to claim 1, wherein at least one flange starts at the tube body in a tangential to radial direction.

3. A tube according to any one of claims 1 or 2, wherein said plate metal of the tube body joins with a free edge thereof with a butt joint to the base region of the at least one flange.

4. A tube according to any one of claims 1 or 2, wherein said plate metal of the tube body, by means of a free edge, establishes contact while overlapping on the inside beyond the base region of the at least one flange.

5. A tube according to any one of claims 1 or 2, wherein said plate metal of the tube body, by means of a free edge bent away from the tube body, establishes parallel contact with the at least one flange on the outside.

6. A tube according to claim 1 or 2, wherein said tube body is welded near the base region of the at least one flange.

7. A tube according to any one of claims 1 or 2, wherein the cross-section, said plate metal of the tube body comprises a variable thickness.

8. A flange tube which is made out of plate metal with a closed cross-section and which comprises at least one flange integrally produced from the plate metal of the tube body and extending in the longitudinal direction and wherein said flange starts at said tube body in a tangential to radial direction and wherein said plate metal of the tube body joins with a free edge thereof with a butt joint to the base region of the at least one flange and wherein said plate metal of the tube body, by means of said free edge establishes contact while overlapping on the inside beyond said base region of said flange.

9. A tube according to claim 8, wherein said flange consists of a thicker material than the region of said closed tube body.

10. A tube according to claim 8, wherein said flange consists of a thinner material than the region of said closed tube body.

11. A tube according to claim 8, wherein said plate metal of the tube body comprises variable thickness along its length.

12. A tube according to claim 11, wherein said wall thickness of said tube body is thinner at its ends than in a central region.

13. A tube according to claim 11, wherein said wall thickness of said tube body is thicker at its ends than in a central region.

14. A tube according to claim 12, wherein said thinner wall regions comprises 15 to 50% of the thickness of the thickest wall regions.

15. A tube according to claims 8 or 14, wherein said wall region of said closed tube body comprises an outer diameter of 30 to 150 mm.

16. A tube according to claims 8 or 14, wherein the width of said flange ranges between 20 and 50 mm.

17. A tube according to claims 8 or 14, wherein said tube body comprises at least one flange-less longitudinal portion.

18. A process of producing a flange tube with a tubular body with a closed cross-section, wherein said flange tube comprises at least one flange formed integrally from the plate metal of a tube body and extending in the longitudinal direction, wherein, in a lower first bending die, by means of a punch, there is produced a profile with a U-shaped cross-section with parallel arms, and in a lower second bending die, by means of an upper-bending die, there is produced said tube body with a closed cross-section from said two arms, wherein there is used at least one of the arms to form a flange portion for the at least one flange extending in the longitudinal direction.

19. A process according to claim 16, wherein the profile with the U-shaped cross-section is produced with parallel arms of different lengths.

20. A process according to claim 17, wherein said tube body is welded in the base region of said flange.

21. A process according to claim 18, wherein the operation process of welding the tube body takes place simultaneously with the operation of connecting said flange to a third part.

22. A tool for producing a flange tube from plate metal with a tube body with a closed cross-section, which flange tube comprises at least one flange integrally formed from the plate metal of said tube body and extending in the longitudinal direction, said tool comprising a lower die part with a substantially semi-cylindrical receiving trough and an upper die part with a substantially semi-cylindrical forming trough which complements the receiving trough to form a cylindrical cross-section, wherein, in the forming trough, there is formed a longitudinally extending blade and, in parallel thereto, at least one planar longitudinal slot for receiving a flange portion for said flange.

23. A tool according to claim 22, wherein in parallel to said longitudinally extending blade, in said forming trough, opposite said planar longitudinal slot, there is formed a second planar longitudinal slot of a lesser depth for receiving a free edge bent away from the tube body.

24. A tool according to claim 22, wherein in parallel to said longitudinally extending blade, in said forming trough, opposite said planar longitudinal slot, there is, formed a second planar longitudinal slot of the same depth for receiving a second flange portion for a double-layer flange.
